(19) United States
(12) Patent Application Publication
(10) Pub. No.: US 2021/0331125 A1
(43) Pub. Date: Oct. 28, 2021

(54) DEVICE AND METHOD FOR MIXING DRESSING, WHIPPING FOOD AND BEVERAGE, AND FROTHING FACIAL CLEANSER, HAIR DRESSING, DETERGENT, CONSTRUCTION MATERIAL, AND MACHINE OIL

(71) Applicant: DD MACHINE WEST JAPAN CO., LTD., HIROSHIMA (JP)

(72) Inventors: MIKINARI MASUMOTO, HIROSHIMA (JP); HAJIME ODANI, TOKYO (JP)

(21) Appl. No.: 16/623,048

(22) PCT Filed: Jun. 14, 2019
(86) PCT No.: PCT/JP2019/023597

§ 371 Date: Dec. 16, 2019

(51) Int. Cl. B01F 11/00; A47J 43/27; A47J 43/10

(52) U.S. Cl. CPC B01F 11/0091; A47J 43/27; A47J 43/1075; B01F 11/0082; B01F 11/0025; B01F 11/0088; B01F 11/0011

(57) ABSTRACT

It is an object of the present invention to provide an agitating device which can be shaken to agitate, whip, froth and disperse the liquid material content.

There is provided a device for mixing liquid material comprising: a container containing liquid material; an opening-closing member formed on the top of said container; and a coil spring accommodated in said container and having an end fixed on the upper part of said container so as to be vibrable and oscillable. The coil spring has a smaller coil pitch in its lowest part than that in its upper part.

### TECHNICAL FIELD

The present invention relates to a device for mixing, whipping or frothing materials by stirring and mixing liquid containing oil and aqueous phases, gas and liquid, or liquid and solid.

### BACKGROUND ART

Disclosed in Patent Document 1 is a food mixing machine which mixes rice and vinegar to make vinegared rice.

Disclosed in Patent Document 2 is a device for kneading flour dough in presence of ozone.

Disclosed in Patent Document 3 is a bottled liquid seasoning which makes meat tender and succulent.

Disclosed in Patent Document 4 is a bottled liquid seasoning containing grated daikon radish which makes a good match with fried foods.

Disclosed in Patent Document 5 is a bottled separated liquid seasoning which is used as a salad dressing after shaking the bottle. The aqueous phase of the liquid seasoning contains crushed vegetables which give good flavor and are hardly precipitable.

Disclosed in Patent Document 6 is a bottled liquid seasoning. The bottle is flexibly deformed such that viscose liquid seasoning can be discharged.

Disclosed in Patent Document 7 is a bottled liquid seasoning containing sesame seeds, oil and dispersant which can be shaken to disperse the sesame seeds.

Disclosed in Patent Document 8 is a stirring device (liquefaction promoting device) adapted for heat pumps which accommodates a vertically-vibrable spiral spring in a cylindrical casing.

Disclosed in Patent Document 9 is an agitation assembly device for agitating salad dressing comprising a tether, a retainer ring coupled to a first end of the retainer and an agitator device coupled to a second end of the retainer, wherein when the retainer ring is coupled to a container, the agitator device and at least a portion of the tether are positioned within an interior of the container.

### PRIOR ART DOCUMENT

### Patent Document

Patent Document 1: Japanese Patent Laid-open No. 2017-212889
Patent Document 2: Japanese Publication No. 4724175.
Patent Document 3: Japanese Patent Laid-open No. 2014-124123.
Patent Document 4: Japanese Patent Laid-open No. 2013-111064.
Patent Document 5: Japanese Patent Published No. 2011-109973.
Patent Document 6: Japanese Patent Laid-open No. 2017-019562.
Patent Document 7: Japanese Patent Laid-open No. 2002-369665.
Patent Document 8: Japanese Patent Laid-open No. 2015-212601.
Patent Document 9: U.S. Patent Publication No. 2015/0290605.

### DISCLOSURE OF THE INVENTION

### Problems to be Solved by the Invention

It has been common to mix and stir food materials so as to improve the taste and mouthfeel (Patent Document 1). The more finely and evenly the food materials are stirred, the better become the taste and mouthfeel. For that purpose, there is proposed a device for kneading flour dough in presence of ozone (Patent Document 2).

There are also proposed liquid seasonings which make meat tender and succulent (Patent Document 3), which make a good match with fried foods (Patent Document 4), which contain an aqueous phase and an oil phase and is used after being shaken (Patent Document 5), or which contain sesame seeds and is used after being shaken so as to disperse the sesame seeds (Patent Document 7).

There is also proposed a bottled liquid seasoning, the bottle being flexibly deformed to ease discharge of the content (Patent Document 6).

There is also proposed a stirring device (liquefaction promoting device) adapted for heat pumps which accommodates a vertically-vibrable spiral spring in a cylindrical casing (Patent Document 8).

There is also proposed an agitation assembly device for agitating salad dressing (Patent Document 9).

There are proposed bottles for containing liquid seasoning of various material, various forms and of various structures (Patent Document 6). There has not been, however, proposed a bottle having a mechanism to disperse and froth the content.

That is considered to be because liquid seasoning usually contains dispersant (Patent Document 8).

When salad dressing is made in households, dispersant is not usually used. The inventors have come upon an idea that a bottle having an agitating means would be convenient as a container of salad dressing to be used in households.

The inventors have also considered that such a container would also be suitable as containers for mass production type salad dressing and it would make it unnecessary to use dispersant in salad dressing.

The inventors have also considered that such a container would also function as an agitating utensil for agitating, for example, flour and water to make pancakes.

The inventors have also considered that such a container would also be useful for agitating and whipping beverages such as milk, green juice, smoothie, etc.

The inventors have also considered that such a container would also be useful for agitating and frothing detergents, construction materials and machine oil.

The inventors, having conducted an intensive research on the mechanism of agitation in such a container, have contrived a container that has a spirally wound vibrable spring which is capable of agitating the content.

It is an object of the present invention to provide an agitating device which can be shaken to agitate, whip, froth and disperse the liquid material content.

### Means for Solving the Problems

The “liquid material” herein means a mixture of liquid (e.g. water) and one or more materials (e.g. oil, powder, grain and the like) to be dispersed in the liquid. The materials do not to have to be evenly mixed with the liquid, but may be separated from or precipitated in the liquid.

According to the present invention, there is provided a device for mixing liquid material comprising: a longitudinally extending container for containing liquid material, which is a mixture of liquid and one or more materials to be dispersed in said liquid; an opening-closing member coupled to the top of said container; and a coil spring accommodated in said container and having an end fixed on the upper part of said container so as to be vibrable and oscillable; wherein said coil spring has a length of 60 to 80% of the inner longitudinal length of said container, said coil spring has a coil pitch of 50%, 75%, 100%, 125% and 150% of the coil diameter each in its first, second, third, forth and fifth upper part, and has a zero coil pitch in its lowest part, said lowest part having 3 to 5 coil turns, and said device is shaken along its longitudinal direction to allow said one or more materials to be dispersed in said liquid such that said liquid material is whipped or frothed.

Configured as such, a user can shake the device to cause the coil spring to vibrate and oscillate, thereby allowing the materials to be in the liquid. The mixed liquid material can be discharged through the opening.

According to the present invention, there is also provided a device for mixing liquid material comprising: a longitudinally extending container for containing liquid material, which is a mixture of liquid and one or more materials to be dispersed in said liquid; an opening-closing member coupled to the top of said container; and a coil spring accommodated in said container and having an end fixed on the upper part of said container so as to be vibrable and oscillable; wherein said coil spring has a length of 60 to 80% of the inner longitudinal length of said container, said coil spring has a coil pitch of 50%, 75%, 100% and 125% of the coil diameter each in its first, second, third and forth upper part, and has a zero coil pitch in its lowest part, said lowest part having 3 to 5 coil turns, and said device is shaken along its longitudinal direction to allow said one or more materials to be dispersed in said liquid such that said liquid material is whipped or frothed.

Configured as such, the densely wound part of the coil spring near the other end thereof functions as a weight so as to facilitate its vibration and oscillation.

According to the present invention, there is also provided a device for mixing liquid material comprising: a longitudinally extending container for containing liquid material, which is a mixture of liquid and one or more materials to be dispersed in said liquid; an opening-closing member coupled to the top of said container; and a coil spring accommodated in said container and having an end fixed on the upper part of said container so as to be vibrable and oscillable; wherein said coil spring has a length of 60 to 80% of the inner longitudinal length of said container, said coil spring has a coil pitch of 125%, 100%, 75, 50%, 75%, 100% and 125% of the coil diameter each in its first, second, third, forth, fifth, sixth and seventh upper part, and has a zero coil pitch in its lowest part, said lowest part having 3 to 5 coil turns, and said device is shaken along its longitudinal direction to allow said one or more materials to be dispersed in said liquid such that said liquid material is whipped or frothed.

Configured as such, the coil spring is allowed to effectively vibrate and oscillate, thereby facilitating mixing of the content.

The device for mixing liquid material according to the present invention is characterized in that said coil spring is made of iron, steel, stainless steel, titanium, titanium alloy or plastics.

Configured as such, the device can be maintained hygienic.

The device for mixing liquid material according to the present invention is characterized in that said coil spring has a wire diameter of 1 to 2 mm.

Configured as such, a user is allowed to shake the device to effectively cause the coil spring to vibrate and oscillate, thereby facilitating mixing of the content.

The device for mixing liquid material according to the present invention is characterized in that said opening-closing member is a screw cap and said container accommodates in its upper part an internal lid which fixes the end of said coil spring thereon, said screw cap and said coil spring being disassemblable from said container.

Configured as such, the device is tightly sealed so as not to leak the content when being shaken.

The device for mixing liquid material according to the present invention is characterized in that said internal lid has a large opening on its center, the inner perimeter of said opening being tapered so as to ease letting out the liquid material.

Configured as such, a user can easily discharge the content out of the device.

The device for mixing liquid material according to the present invention is characterized in that said screw cap is fastened on said container so as to fix said internal lid and the end of said coil spring with respect to said container, thereby allowing the device to be shaken along its longitudinal direction by a user's hand.

Configured as such, the device can be easily assembled.

The device for mixing liquid material according to the present invention is characterized in that said container is equipped with a packing between the top thereof and said screw cap, thereby improving the sealability of the device.

Configured as such, the device is tightly sealed so as not to leak the content when being shaken.

The device for mixing liquid material according to the present invention is characterized in that it further comprises another opening-closing member formed on the bottom of said container.

Configured as such, a user can also discharge the content through the other opening of the device.

The device for mixing liquid material according to the present invention is characterized in that wherein said screw cap has a flat upper surface.

Configured as such, the device is capable of self-standing.

According to the present invention, there is provided a method of mixing liquid seasoning containing an aqueous phase and an oil phase using the above-described device comprising the steps of: providing liquid seasoning containing an aqueous phase and an oil phase in said container; fastening said opening-closing member; shaking the device by hand along its longitudinal direction; and discharging the mixed content.

According to the present invention, there is provided a method of mixing food containing an aqueous phase and an oil phase using the above-described device comprising the steps of providing food in said container; fastening said opening-closing member; shaking the device by hand along its longitudinal direction; and discharging the mixed content.

According to the present invention, there is provided a method of mixing beverage containing an aqueous phase and an oil phase using the above-described device comprising the steps of: providing beverage in said container; fastening said opening-closing member; shaking the device by hand along its longitudinal direction; and discharging the mixed content.

According to the present invention, there is provided a method of mixing facial cleanser containing an aqueous phase and an oil phase using the above-described device comprising the steps of: providing facial cleanser in said container; fastening said opening-closing member; shaking the device by hand along its longitudinal direction; and discharging the mixed content.

According to the present invention, there is provided a method of mixing hair dressing containing an aqueous phase and an oil phase using the above-described device comprising the steps of: providing hair dressing in said container; fastening said opening-closing member; shaking the device by hand along its longitudinal direction; and discharging the mixed content.

According to the present invention, there is provided a method of mixing detergent containing an aqueous phase and an oil phase using the above-described device comprising the steps of: providing detergent in said container; fastening said opening-closing member; shaking the device by hand along its longitudinal direction; and discharging the mixed content.

According to the present invention, there is provided a method of mixing construction material containing an aqueous phase and an oil phase using the above-described device comprising the steps of: providing construction material in said container; fastening said opening-closing member; shaking the device by hand along its longitudinal direction; and discharging the mixed content.

According to the present invention, there is provided a method of mixing machine oil containing an aqueous phase and an oil phase using the above-described device comprising the steps of: providing machine oil in said container; fastening said opening-closing member; shaking the device by hand along its longitudinal direction; and discharging the mixed content.

The device for mixing liquid material according to the present invention is characterized in that said container is transparent. Configured as such, the state of the content is visible.

### Effects of the Invention

As described in the above, the present invention provides a device and method for mixing dressing, whipping food and beverage, and frothing facial cleanser, hair dressing, detergent, construction material and machine oil. A user can shake the device to cause the coil spring to vibrate and oscillate, thereby allowing the materials to be in the liquid. The mixed liquid material can be discharged through the opening.

### BRIEF DESCRIPTION OF THE DRAWINGS

FIG. 1 is a perspective view showing the outlook of the device for mixing liquid material 1 according to the present invention.

FIG. 2 is an axial cross section view of the device for mixing liquid material 1.

FIG. 3 shows an exploded view of the device for mixing liquid material 1.

FIG. 4 includes a view (4(a)) showing the device for mixing liquid material in the state that it contains liquid material, and a view (4(b)) showing the device for mixing liquid material in the state that it contains liquid material and has the opening-closing member and the coil spring fastened thereon.

FIG. 5 includes a view (5(a)) showing the device for mixing liquid material in the state that it is shaken with level 1 strength with the coil spring fixed thereon, and a view (5(b)) showing the device for mixing liquid material 1 in the state that it is shaken with level 1 strength without the coil spring.

FIG. 6 includes a view (6(a)) showing the device for mixing liquid material in the state that it is shaken with level 2 strength with the coil spring fixed thereon, and a view (6(b)) showing the device for mixing liquid material 1 in the state that it is shaken with level 2 strength without the coil spring.

FIG. 7 includes a view (7(a)) showing the device for mixing liquid material in the state that it is shaken with level 3 strength with the coil spring fixed thereon, and a view (7(b)) showing the device for mixing liquid material 1 in the state that it is shaken with level 3 strength without the coil spring.

FIG. 8 includes a view (8(a)) showing the device for mixing liquid material in the state that it is shaken with level 4 strength with the coil spring fixed thereon, and a view (8(b)) showing the device for mixing liquid material 1 in the state that it is shaken with level 4 strength without the coil spring.

FIG. 9 includes a view (9(a)) showing the device for mixing liquid material in the state that it has been left standing for one hour after being shaken with the coil spring fixed thereon, and a view (9(b)) showing the device for mixing liquid material in the state that it has been left standing for one hour after being shaken without the coil spring.

FIG. 10 is includes five views showing examples of coil springs A, B, C, D and E each having different coil pitch.

FIG. 11 shows a table of the experimental results on the stirring effects of the stirring devices having the coil springs A, B, C, D and E.

FIG. 12 is a view showing another embodiment of the device for mixing liquid material according to the present invention.

FIGS. 13 and 14 show processes of whipping milk using the device for mixing liquid material.

FIGS. 15 and 16 show processes of whipping smoothie using the device for mixing liquid material.

FIGS. 17 and 18 show processes of frothing detergents using the device for mixing liquid material.

FIG. 19 shows processes of agitating dressing using the device for mixing liquid material.

### BEST MODE FOR CARRYING OUT THE INVENTION

Described hereinafter with reference to the attached drawings are detailed embodiments of the device and method according to the present invention. In the figures, like reference numerals refer to like members which have similar basic composition and operation.

### First Embodiment

### <Configuration>

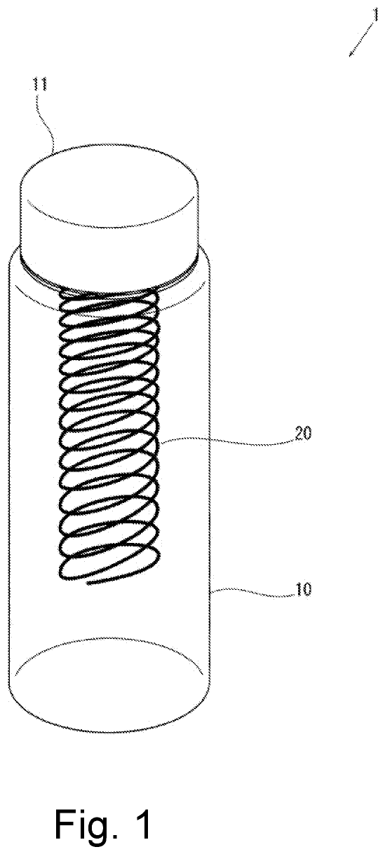

FIG. 1 is a perspective view showing the outlook of a device for mixing liquid material 1 according to the present invention. It has a container 10 which contains liquid material. It is desirably made of transparent or opaque material so as to make visible the status of the content, be it mixed, precipitated or dispersed. The container 10 is also desirably capable of self-standing.

Although the container 10 is depicted in a cylindrical shape is shown in FIG. 1, it may be in any other shapes.

The container 10 is equipped with an opening-closing member 11 coupled to its top, through which the liquid material is let in and out. In the present embodiment, the opening-closing member 10 is made of a screw cap. It is desirable that the screw cap seals the top of the container 10 tight enough that the content does not leak even when the device is shaken by hand. The screw cap can be replaced with a fitting cap or any other types of caps as long as it seals the top of the container 10 tight enough.

FIG. 1 shows the device for mixing liquid material 1 with the opening-closing member 11 being fastened. Accommodated in the container 10 is a coil spring 20. The coil spring 20 has its upper end fixed on the container 10 and its lower part unfixed, vibrable and oscillable. The coil spring 20 may be made of iron, steel, stainless steel, titanium, titanium alloy or plastics. The wire of the coil spring 20 may have roughened surfaces.

As shown in FIG. 1, the coil spring 20 has a perimeter smaller than that of the container 10. This allows the coil spring 20 to vibrate and oscillate when the device 1 is shaken by a user's hand. Then term “oscillate” or “oscillable” herein describes the coil spring 20 oscillating in its extending and shrinking direction and the term “vibrate” or “vibrable” herein describes the coil spring 20 vibrating in directions different from its extending and shrinking direction.

The coil spring 20 desirably has a length of 60 to 80% of the inner longitudinal length of the container 10. A coil spring shorter than this does not effectively stir the content, and a coil spring longer than this does not have enough flexibility of vibration and oscillation.

The coil spring 20 vibrates and oscillates to shear the liquid material. If the coil spring 20 has roughened surfaces, it has higher shearing effect. The shearing effect of the coil spring 20 effectively allows the liquid material to be evenly mixed and dispersed.

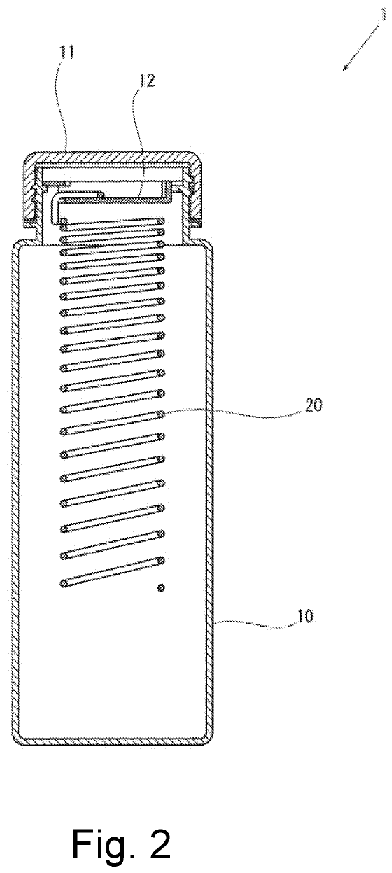

FIG. 2 is an axial cross section view of the device for mixing liquid material 1. The upper part of the container 10 and the inner wall of the opening-closing member 11, or the screw cap, are threaded. The container 10 accommodates in its upper part an internal lid 12. The internal lid 12 fixes thereon the upper end of the coil spring 20.

It is desirable that the internal lid 12 and the coil spring 20 are disassemblable from the container 10 so as to be easily cleaned. It is also desirable that the opening-closing member 11 can be fastened on the container tight enough so as to firmly fix the internal lid 12 and the upper end of the coil spring 20 on the container 10.

It is also desirable that the internal lid 12 has a large opening on its center, and the inner perimeter of the opening is tapered so as to ease letting out the liquid material.

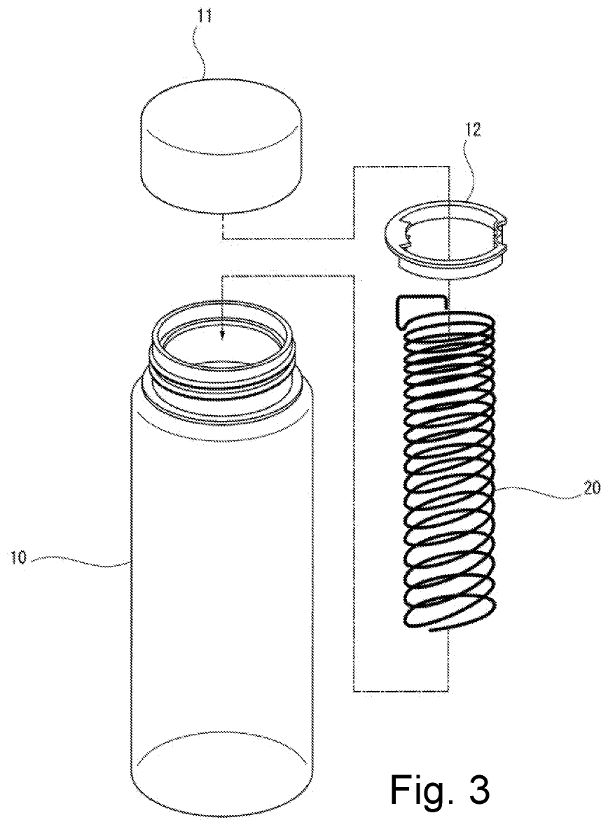

FIG. 3 shows an exploded view of the device for mixing liquid material 1. As shown in FIG. 3, the internal lid 12 has a large opening on its center such that the liquid material can be easily let in and out therethrough. The internal lid 12 has the tapered inner perimeter such that the liquid material can be smoothly let in and out therethrough.

The internal lid 12 is configured such that the coil spring 20 can be mounted thereon. The uppermost part of the wire of the coil spring 20 is bent so as to be mounted on the internal lid 12.

As shown in FIG. 3, the coil spring 20 is mounted on the internal lid 12, and accommodated in the container 10, and then the internal lid 12 is fixed on the upper part of the container 10. Then, the opening-closing member 11 is fastened on the container 10. In this way, the device for mixing liquid material 1 is assembled.

The container 10 is equipped with a packing between its top and the opening-closing member 11 so as to improve the sealability of the device 1.

### <Dispersing Vegetable Oil in Water>

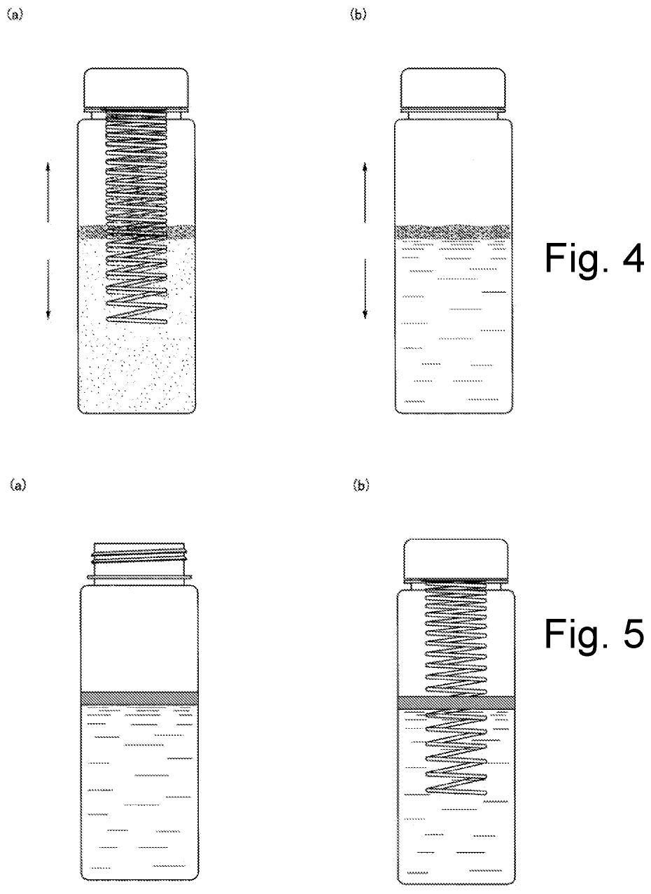

FIG. 4 includes a view (4(a)) showing the device for mixing liquid material 1 in the state that it contains liquid material, and a view (4(b)) showing the device for mixing liquid material 1 in the state it contains liquid material and has the opening-closing member 11 and the coil spring 20 fastened thereon.

The container 10 is made of a transparent bottle with 500 ml capacity. As shown in FIG. 4, the container 10 contains 300 ml of water and 25 ml of vegetable oil, and the oil phase is separated from and above the aqueous phase.

The extent of strength with which a user shakes the device is classified into levels 1 to 4. Higher level indicates higher extent of strength.

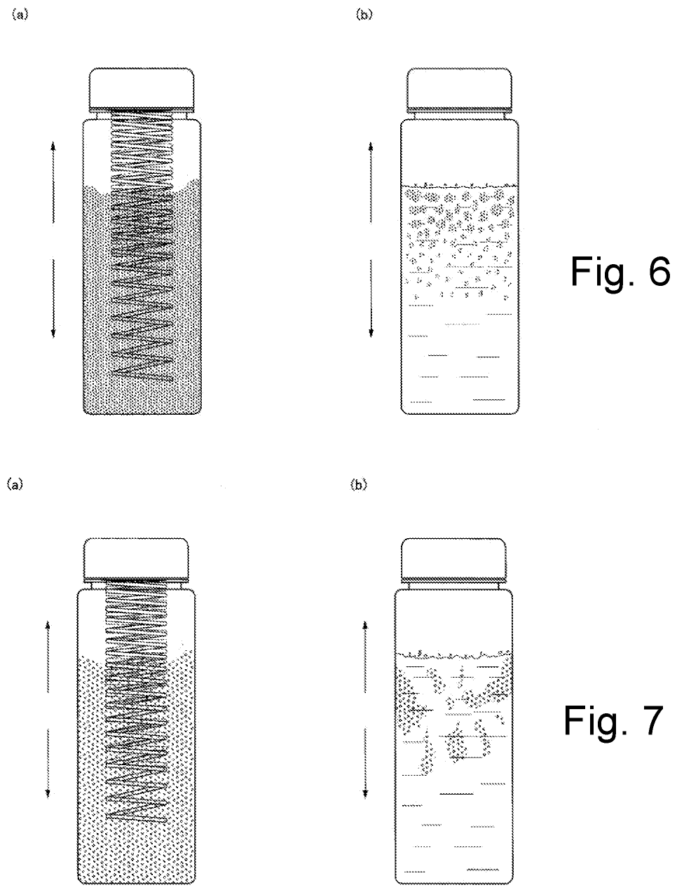

FIG. 5 includes a view (5(a)) showing the device for mixing liquid material 1 in the state that it is shaken with level 1 strength with the coil spring 20 fixed thereon, and a view (5(b)) showing the device for mixing liquid material 1 in the state that it is shaken with level 1 strength without the coil spring 20.

When the coil spring 20 is present, the elastic energy of the coil spring 20 causes the oil phase to be micronized. It is observed that some of the oil has been micronized into oil drops and dispersed in the aqueous phase.

When the coil spring 20 is not present, the oil phase is not micronized.

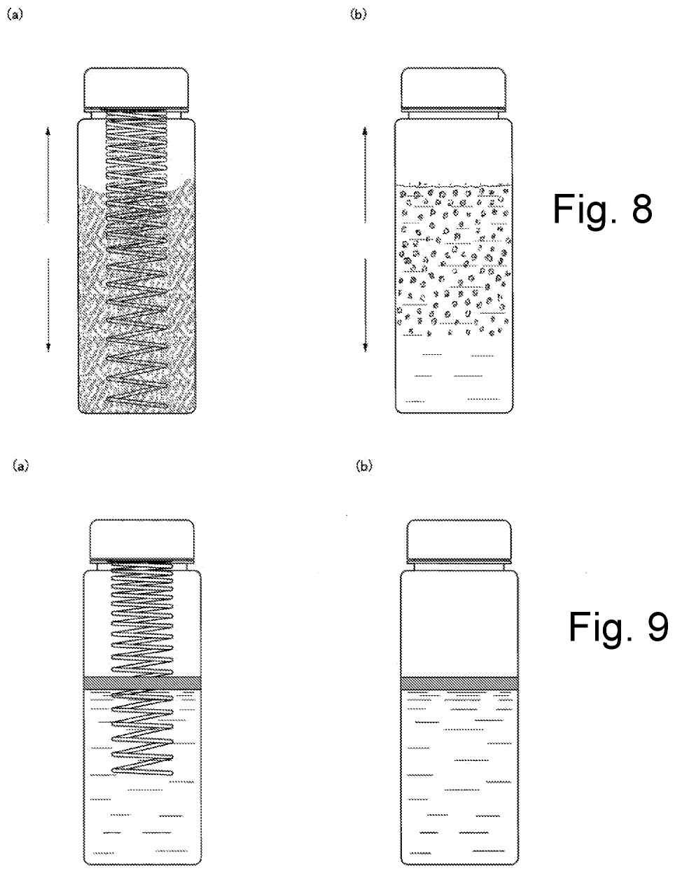

FIG. 6 includes a view (6(a)) showing the device for mixing liquid material 1 in the state that it is shaken with level 2 strength with the coil spring 20 fixed thereon, and a view (6(b)) showing the device for mixing liquid material 1 in the state that it is shaken with level 2 strength without the coil spring 20.

When the coil spring 20 is present, the elastic energy of the coil spring 20 causes the oil phase to be micronized and scattered. It is observed that most of the oil has been scattered in the aqueous phase and some of the oil has been micronized into oil drops and dispersed in the aqueous phase.

When the coil spring 20 is not present, some of the oil has been scattered in the aqueous phase.

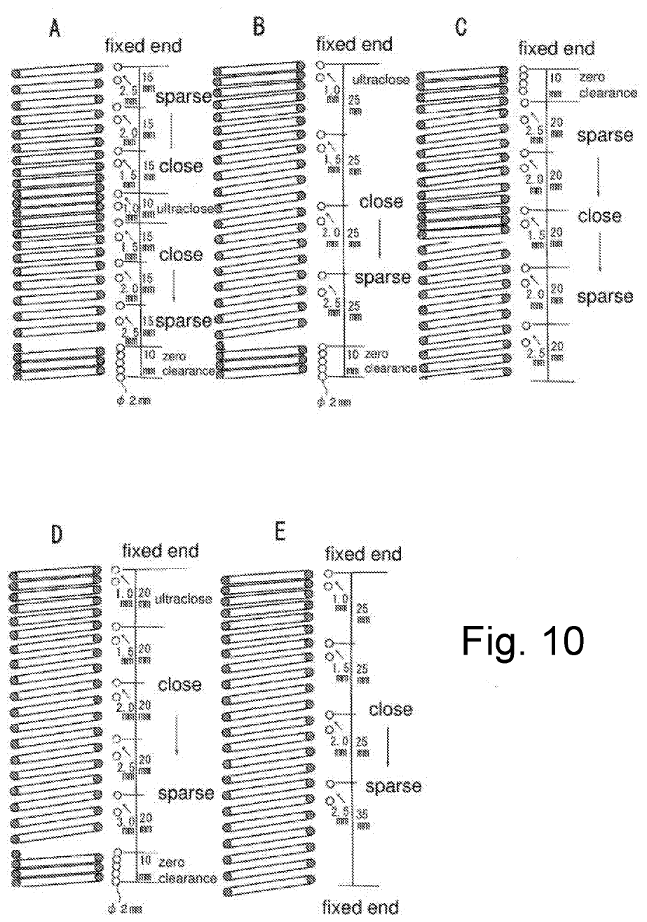

FIG. 7 includes a view (7(a)) showing the device for mixing liquid material 1 in the state that it is shaken with level 3 strength with the coil spring 20 fixed thereon, and a view (7(b)) showing the device for mixing liquid material 1 in the state that it is shaken with level 3 strength without the coil spring 20.

When the coil spring 20 is present, the elastic energy of the coil spring 20 causes the oil phase to be micronized and scattered. It is observed that most of the oil has been micronized into oil drops, evenly scattered, and evenly dispersed in the aqueous phase.

When the coil spring 20 is not present, some of the oil has been scattered in the aqueous phase and others dispersed in the aqueous phase.

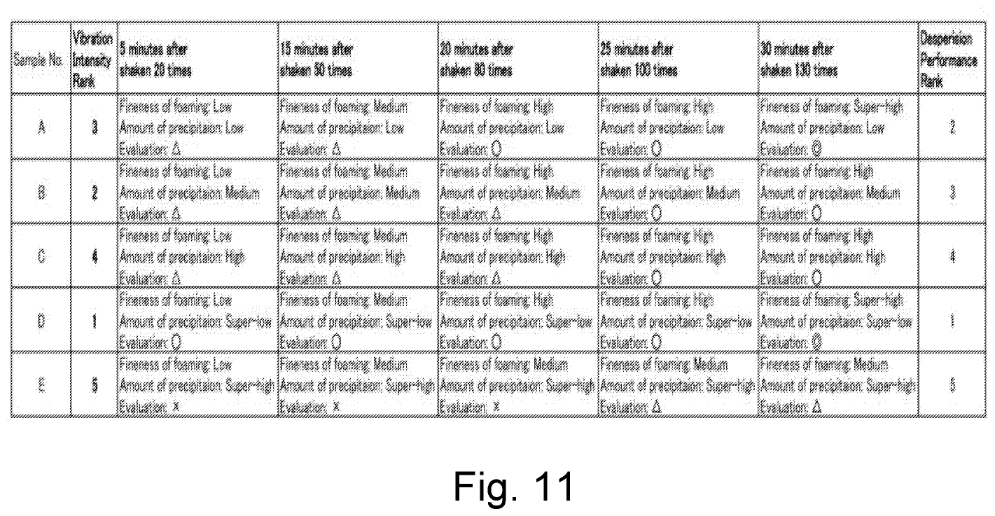

FIG. 8 includes a view (8(a)) showing the device for mixing liquid material 1 in the state that it is shaken with level 4 strength with the coil spring 20 fixed thereon, and a view (8(b)) showing the device for mixing liquid material 1 in the state that it is shaken with level 4 strength without the coil spring 20.

When the coil spring 20 is present, the elastic energy of the coil spring 20 causes the oil phase to be super-micronized and scattered. It is observed that almost all of the oil has been super-micronized into tiny oil drops, evenly scattered, and evenly dispersed in the aqueous phase, and turned into a yellow white mixture.

When the coil spring 20 is not present, some of the oil has been scattered in the aqueous phase and others dispersed in the aqueous phase.

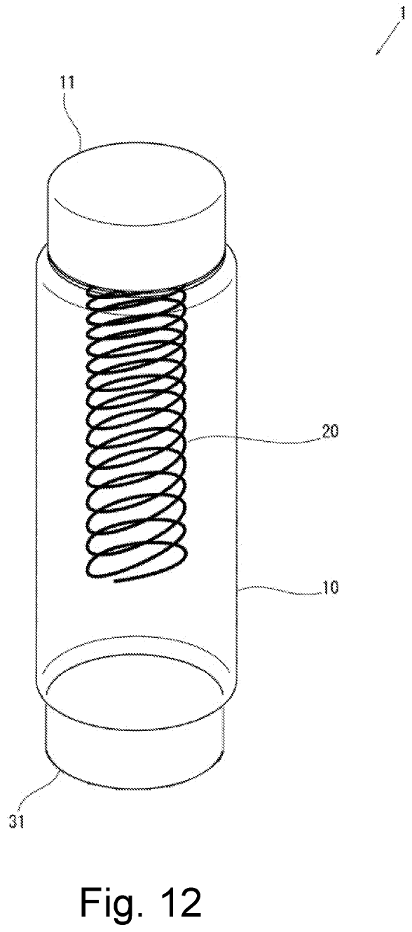

FIG. 9 includes a view (9(a)) showing the device for mixing liquid material 1 in the state that it has been left standing for one hour after being shaken with level 4 strength with the coil spring 20 fixed thereon, and a view (9(b)) showing the device for mixing liquid material 1 in the state that it has been left standing for one hour after being shaken with level 4 strength without the coil spring 20.

When the coil spring 20 is present, it is observed that the aqueous phase has high transparency as the oil phase is still super-micronized and well dispersed.

When the coil spring 20 is not present, it is observed that the aqueous phase has low transparency as the oil phase is not well micronized nor dispersed.

The coil spring 20 is vibrated and oscillated by its restoring force. Deformation of the coil spring 20 causes it to discharge the accumulated elastic energy and to do mechanical work. It is confirmed that the coil spring 20 oscillating in its extending and shrinking direction at its eigenfrequency causes oil in water to be super-micronized.

<Experiment Using Coil Spring with Various Coil Pitch>

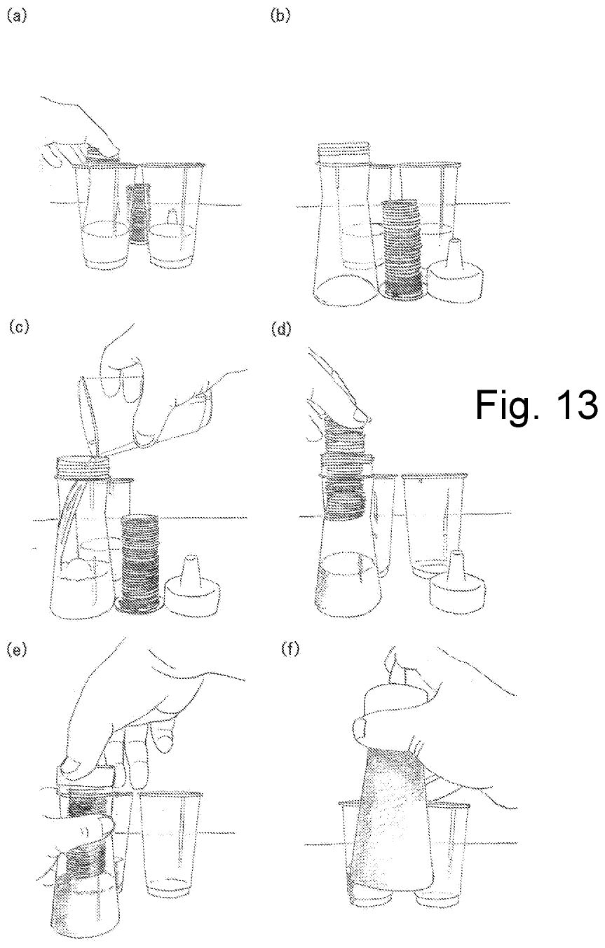

FIG. 10 is includes five views showing examples of coil springs A, B, C, D and E each having different coil pitch. The five springs each has a length of 11 cm (110 mm) and has its one end fixed on the internal lid of the container, although the container, the opening-closing member and the internal lid are not shown in the figure.

The coil spring is made of steel having a wire diameter of 1 to 2 mm.

The coil spring A has from top to bottom a first part with a length of 15 mm and a coil pitch of 2.5 mm, a second part with a length of 15 mm and a coil pitch of 2.0 mm, a third part with a length of 15 mm and a coil pitch of 1.5 mm, a forth part with a length of 10 mm and a coil pitch of 1.0 mm, a fifth part with a length of 15 mm and a coil pitch of 1.5 mm, a sixth part with a length of 15 mm and a coil pitch of 2.0 mm, a seventh part with a length of 15 mm and a coil pitch of 2.5 mm and an eighth part with a length of 10 mm and a coil pitch of 0.0 mm. The bottom of the coil spring is unfixed.

The coil spring B has from top to bottom a first part with a length of 25 mm and a coil pitch of 1.0 mm, a second part with a length of 25 mm and a coil pitch of 1.5 mm, a third part with a length of 25 mm and a coil pitch of 2.0 mm, a forth part with a length of 25 mm and a coil pitch of 2.5 mm and a fifth part with a length of 10 mm and a coil pitch of 0.0 mm. The bottom of the coil spring is unfixed.

The coil spring C has from top to bottom a first part with a length of 10 mm and a coil pitch of 1.0 mm, a second part with a length of 20 mm and a coil pitch of 2.5 mm, a third part with a length of 20 mm and a coil pitch of 2.0 mm, a forth part with a length of 20 mm and a coil pitch of 1.5 mm, a fifth part with a length of 20 mm and a coil pitch of 2.0 mm and a sixth part with a length of 20 mm and a coil pitch of 2.5 mm. The bottom of the coil spring is unfixed.

The coil spring D has from top to bottom a first part with a length of 20 mm and a coil pitch of 1.0 mm, a second part with a length of 20 mm and a coil pitch of 1.5 mm, a third part with a length of 20 mm and a coil pitch of 2.0 mm, a forth part with a length of 20 mm and a coil pitch of 2.5 mm, a fifth part with a length of 20 mm and a coil pitch of 3.0 mm and a sixth part with a length of 10 mm and a coil pitch of 0.0 mm. The bottom of the coil spring is unfixed.

The coil spring E has from top to bottom a first part with a length of 25 mm and a coil pitch of 1.0 mm, a second part with a length of 25 mm and a coil pitch of 1.5 mm, a third part with a length of 25 mm and a coil pitch of 2.0 mm and a forth part with a length of 35 mm and a coil pitch of 2.5 mm. The bottom of the coil spring is fixed.

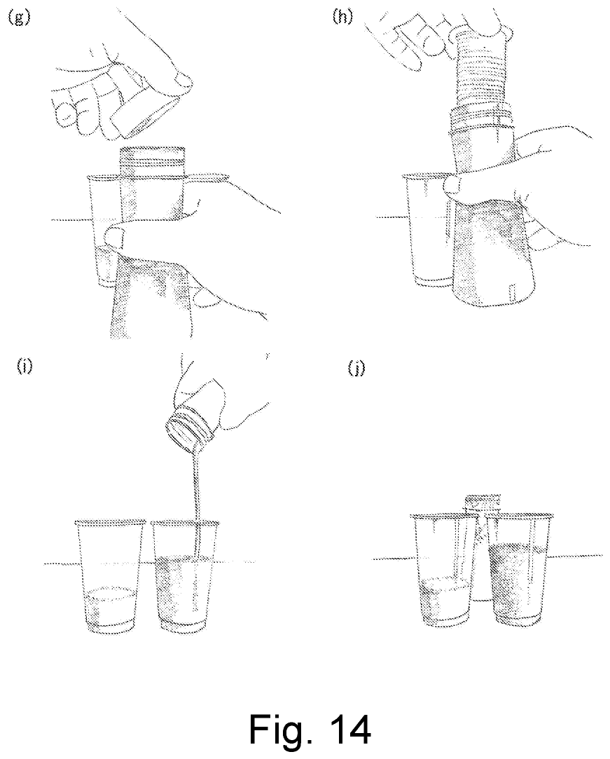

FIG. 11 shows a table of the experimental results on the stirring effects of the stirring devices having the coil springs A, B, C, D and E.

When the stirring devices were shaken by hand, the coil spring D vibrated the most intensively, followed by the coil springs B, A, C and E.

As shown in the table of FIG. 11, we observed the states of the stirring devices 5 minutes after being shaken 20 times, 15 minutes after being shaken 50 times, 20 minutes after being shaken 80 times, 25 minutes after being shaken 100 times, and 30 minutes after being shaken 130 times.

In the table of FIG. 11, the double circle mark means that the content of the stirring devices was thoroughly dispersed, the circle mark means that the content of the stirring devices was sufficiently dispersed, the triangle mark means that the content of the stirring devices was insufficiently dispersed, and the X mark means that the content of the stirring devices was hardly dispersed.

It was observed that the stirring device having the coil spring D demonstrated the highest dispersion performance, followed by the stirring devices having the coil springs A, B, C and E.

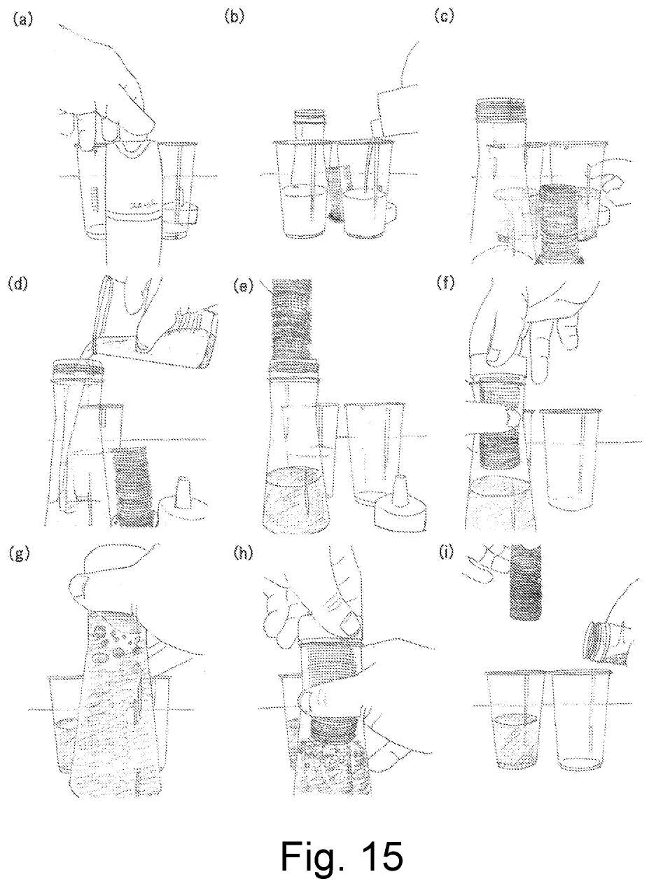

FIG. 12 is a view showing another example of the device for mixing liquid material according to the present invention. As shown in FIG. 12, the device for mixing liquid material 1 comprises an opening-closing member 31 to be coupled to the bottom of the container 10 in addition to the opening-closing member 11. The opening-closing member 10 can be made of a screw cap. It is desirable that the opening-closing member 10 has a flat bottom such that the container 10 is capable of self-standing. The container 10 is equipped with a packing between its bottom and the opening-closing member 31 so as to improve the sealability of the device 1.

It is further desirable that both the opening-closing members 11 and 31 have flat bottoms such that the container 10 is capable of self-standing even it is turned upside-down.

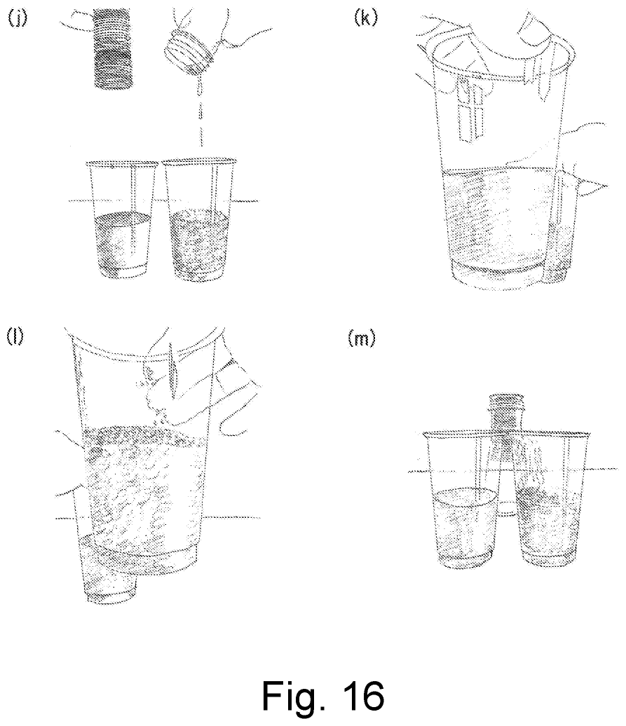

FIGS. 13 and 14 show processes of whipping milk using the device for mixing liquid material.

(a) Pour 50 cc of milk into each of two cups.

(b) The device is prepared in a disassembled state. In this example, the opening-closing member has a projection formed with a discharging port on its tip.

(c) Pour milk from one of the cups into the container of the device.

(d) Insert the coil spring into the container.

(e) Couple the opening-closing member tightly to the top of the container.

(f) Shake the device 50 times by hand.

(g) Uncouple the opening-closing member.

(h) Remove the coil spring from the container.

(i) Pour the content (whipped milk) back into the cup.

(j) Comparing the two cups, the milk has been shaken in the device and well whipped.

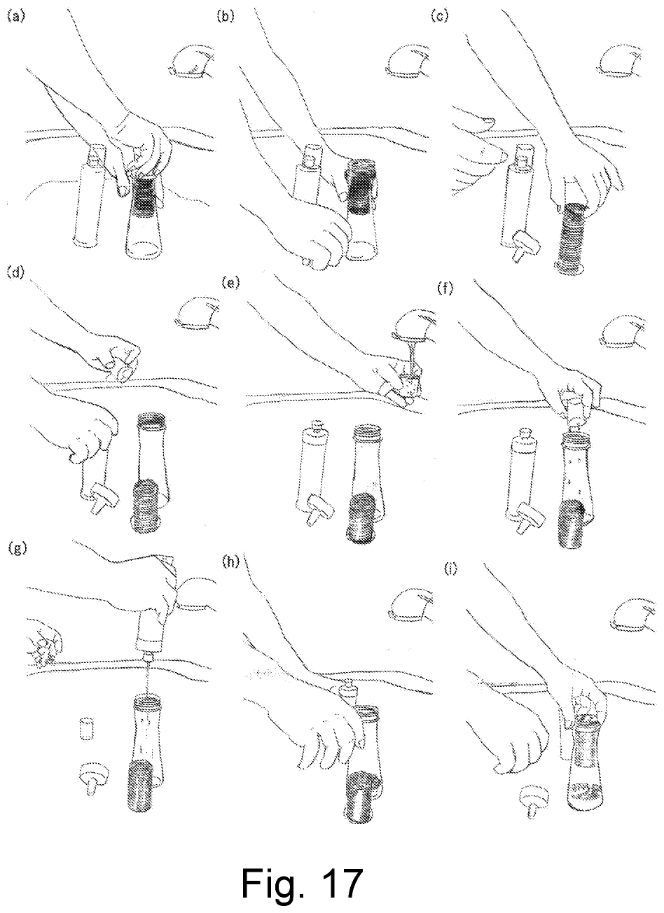

FIGS. 15 and 16 show processes of whipping smoothie using the device for mixing liquid material.

(a) Prepare a commercially available bottle of smoothie and open its lid.

(b) Pour smoothie into two cups in equal amount.

(c) The device is prepared in a disassembled state. In this example, the opening-closing member has a projection formed with a discharging port on its tip.

(d) Pour smoothie from one of the cups into the container of the device.

(e) Insert the coil spring into the container.

(f) Couple the opening-closing member tightly to the top of the container.

(g) Shake the device 50 times by hand.

(h) Uncouple the opening-closing member.

(i) Remove the coil spring from the container.

(j) Pour the content (whipped milk) back into the cup.

(k) (l) (m) Comparing the two cups, the smoothie has been shaken in the device and well whipped.

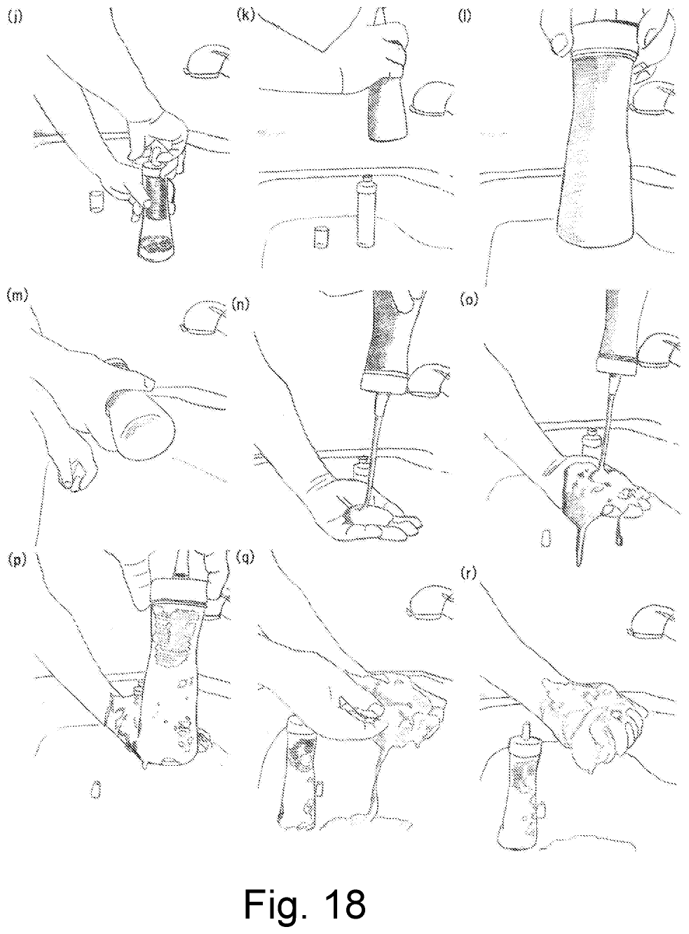

FIGS. 17 and 18 show processes of frothing detergents using the device for mixing liquid material.

(a) (b) (c) Prepare the device in an assembled state and disassemble it. In this example, the opening-closing member has a projection formed with a discharging port on its tip.

(d) (e) (f) Using a measuring cup, pour 30 cc of water into the container of the device.

(g) Pour 10 cc of detergents into the container of the device.

(h) (i) Insert the coil spring into the container.

(j) Couple the opening-closing member tightly to the top of the container.

(k) (l) Shake the device 50 times by hand.

(m) Uncouple the opening-closing member.

(n) (o) Open the discharging port and squeeze the container to discharge the frothed detergent.

(p) (q) (r) The detergent has been shaken in the device and well frothed.

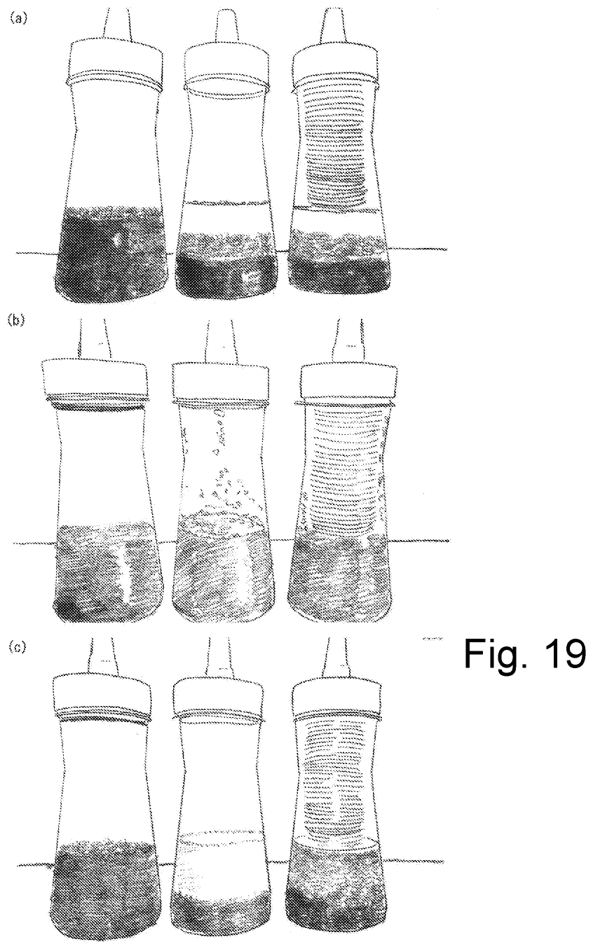

FIG. 19 shows various states of the devices for mixing liquid material 1.

In FIG. 19(a):

the device on the left side has no coil spring;

the device on the center has no coil spring;

the device on the right side has a coil spring;

and these devices have yet to be shaken.

In FIG. 19(b):

the device on the left side has no coil spring;

the device on the center has no coil spring;

the device on the right side has a coil spring;

and devices on the center and on the right side have just been shaken for 100 times.

In FIG. 19(c):

the device on the left side has no coil spring;

the device on the center has no coil spring;

the device on the right side has a coil spring;

and devices on the center and on the right side were shaken for 100 times and had been left standing for 3 days.

It is observed that the content agitated using the device with a coil spring remains to be well dispersed for 3 days.

### <Mechanism of Action>

Described below are the mechanisms of action of the device for mixing liquid material according to the present invention.

One mechanism of action is that the vibration and oscillation of the coil spring agitates liquid material such that clusters of oil, particles and precipitations are sheared into a dispersed state.

Another mechanism of action is overtone resonance (scaling resonance). The vibration and oscillation of the coil spring does not only agitate liquid material but also produces sound, which may or may not be in audible frequency. Such sound is continuously produced during the time that the device is being shaken. Clash of clusters of oil, particles and precipitations also produce sound. The sound produced by the vibration and oscillation of the coil spring and the sound produced by the clash of clusters of oil, particles and precipitations are considered to be in harmonic relationship as the over tone of the former (higher harmonics) resonates the latter (scaling resonance). This promotes dispersion of oil, particles and precipitations.

Scaling resonance is a phenomenon that higher harmonics or overtone, which is tens of octaves higher, causes resonance. (Yoichi Fukagawa (1999), Protein Music, Tokyo, Chikuma-shobo.)

Resonance and sympathizing are distinguished herein. Whereas sympathizing occurs when vibration or oscillation is transmitted via solid, resonance occurs when vibration or oscillation is transmitted via fluid such as water and gas.

In the device for mixing liquid material according to the present invention, it is considered that the vibration and oscillation of the coil spring is transmitted to oil, particles and precipitations via fluid (liquid material) and thus overtone resonance (scaling resonance) occurs when the device is being shaken.

In the device for mixing liquid material according to the present invention, liquid material, viewed from a macro-viewpoint, imparts impact to the coil spring and causes it to be vibrated and oscillated. Liquid material, viewed from a micro-viewpoint, clusters of oil, particles and precipitations contained in it are caused to be declustered by the action of overtone resonance (scaling resonance) and evenly dispersed.

### Applications

The device for mixing liquid material according to the present invention is applicable to devices for frothing construction material, detergents, hair dressing and facial cleanser.

The device for mixing liquid material according to the present invention is also applicable to devices for frothing machine oil for various kinds of machines used in chemical, construction and food processing industries.

Examples of such machines are hydraulic pumps, boilers and motors. The device for mixing liquid material according to the present invention is particularly useful in providing frothed machine oil for hydraulic pumps and hydraulic machines on site.

### Other Applications

The device for mixing liquid material according to the present invention is also applicable to devices for whipping food and beverage, and mixing liquid material and liquid seasoning.

### INDUSTRIAL APPLICABILITY

The present invention provides a whipper and a container for dressing which contains an aqueous phase and an oil phase. It can also be used as a whippier and a container for dispersing flour in water, whipping milk, etc. It can also be used as a whippier and a container for agitating and frothing construction materials, detergents, hair dressing, facial cleanser and machine oil.

### REFERENCE SYMBOLS

1 device for mixing liquid material
10 container
11 opening-closing member
12 internal lid
20 coil spring
31 opening-closing member

1. A device for mixing liquid material comprising:
a longitudinally extending container for containing liquid material, which is a mixture of liquid and one or more materials to be dispersed in said liquid;
an opening-closing member coupled to the top of said container; and
a coil spring accommodated in said container and having an end fixed on the upper part of said container so as to be vibrable and oscillable; wherein
said coil spring has a length of 60 to 80% of the inner longitudinal length of said container,
said coil spring has a coil pitch of 50%, 75%, 100%, 125% and 150% of the coil diameter each in its first, second, third, forth and fifth upper part, and has a zero coil pitch in its lowest part, said lowest part having 3 to 5 coil turns, and
said device is shaken along its longitudinal direction to allow said one or more materials to be dispersed in said liquid such that said liquid material is whipped or frothed.

2. A device for mixing liquid material comprising:
a longitudinally extending container for containing liquid material, which is a mixture of liquid and one or more materials to be dispersed in said liquid;
an opening-closing member coupled to the top of said container; and
a coil spring accommodated in said container and having an end fixed on the upper part of said container so as to be vibrable and oscillable; wherein
said coil spring has a length of 60 to 80% of the inner longitudinal length of said container,
said coil spring has a coil pitch of 50%, 75%, 100% and 125% of the coil diameter each in its first, second, third and forth upper part, and has a zero coil pitch in its lowest part, said lowest part having 3 to 5 coil turns, and
said device is shaken along its longitudinal direction to allow said one or more materials to be dispersed in said liquid such that said liquid material is whipped or frothed.

3. A device for mixing liquid material comprising:
a longitudinally extending container for containing liquid material, which is a mixture of liquid and one or more materials to be dispersed in said liquid;
an opening-closing member coupled to the top of said container; and
a coil spring accommodated in said container and having an end fixed on the upper part of said container so as to be vibrable and oscillable; wherein
said coil spring has a length of 60 to 80% of the inner longitudinal length of said container,
said coil spring has a coil pitch of 125%, 100%, 75, 50%, 75%, 100% and 125% of the coil diameter each in its first, second, third, forth, fifth, sixth and seventh upper part, and has a zero coil pitch in its lowest part, said lowest part having 3 to 5 coil turns, and
said device is shaken along its longitudinal direction to allow said one or more materials to be dispersed in said liquid such that said liquid material is whipped or frothed.

4. (canceled)

5. (canceled)

6. The device for mixing liquid material as set forth in claim 1, wherein said opening-closing member is a screw cap and said container accommodates in its upper part an internal lid which fixes the end of said coil spring thereon, said internal lid and said coil spring being disassemblable from said container.

7. The device for mixing liquid material as set forth in claim 6, wherein said internal lid has a large opening on its center, the inner perimeter of said opening being tapered so as to ease letting out the liquid material.

8. The device for mixing liquid material as set forth in claim 6, wherein said screw cap is fastened on said container so as to fix said internal lid and the end of said coil spring with respect to said container, thereby allowing the device to be shaken along its longitudinal direction by a user's hand.

9. The device for mixing liquid material as set forth in claim 6, wherein said container is equipped with a packing between the top thereof and said screw cap, thereby improving the sealability of the device.

10. The device for mixing liquid material as set forth in claim 1, further comprising another opening-closing member formed on the bottom of said container.

11. (canceled)

12. (canceled)

13. (canceled)

14. (canceled)

15. (canceled)

16. (canceled)

17. (canceled)

18. (canceled)

19. (canceled)

20. The device for mixing liquid material as set forth in claim 2, wherein said opening-closing member is a screw cap and said container accommodates in its upper part an internal lid which fixes the end of said coil spring thereon, said internal lid and said coil spring being disassemblable from said container.

21. The device for mixing liquid material as set forth in claim 20, wherein said internal lid has a large opening on its center, the inner perimeter of said opening being tapered so as to ease letting out the liquid material.

22. The device for mixing liquid material as set forth in claim 20, wherein said screw cap is fastened on said container so as to fix said internal lid and the end of said coil spring with respect to said container, thereby allowing the device to be shaken along its longitudinal direction by a user's hand.

23. The device for mixing liquid material as set forth in claim 20, wherein said container is equipped with a packing between the top thereof and said screw cap, thereby improving the sealability of the device.

24. The device for mixing liquid material as set forth in claim 2, further comprising another opening-closing member formed on the bottom of said container.

25. The device for mixing liquid material as set forth in claim 3, wherein said opening-closing member is a screw cap and said container accommodates in its upper part an internal lid which fixes the end of said coil spring thereon, said internal lid and said coil spring being disassemblable from said container.

26. The device for mixing liquid material as set forth in claim 25, wherein said internal lid has a large opening on its center, the inner perimeter of said opening being tapered so as to ease letting out the liquid material.

27. The device for mixing liquid material as set forth in claim 25, wherein said screw cap is fastened on said container so as to fix said internal lid and the end of said coil spring with respect to said container, thereby allowing the device to be shaken along its longitudinal direction by a user's hand.

28. The device for mixing liquid material as set forth in claim 25, wherein said container is equipped with a packing between the top thereof and said screw cap, thereby improving the sealability of the device.

29. The device for mixing liquid material as set forth in claim 3, further comprising another opening-closing member formed on the bottom of said container.
